(19) United States
(12) Patent Application Publication
(10) Pub. No.: US 2006/0130686 A1
(43) Pub. Date: Jun. 22, 2006

(54) Printing press

(75) Inventor: Iwao Miyagi, Ibaraki (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Komori Corporation

(21) Appl. No.: 11/302,042

(22) Filed: Dec. 12, 2005

(30) Foreign Application Priority Data
Dec. 17, 2004 (JP) 366529/2004

(51) Int. Cl. B41F 31/00

(52) U.S. Cl. 101/350.1

(57) ABSTRACT

A printing press includes a dampening device, inking device, and fan roller. The dampening device efficiently supplies dampening water to a plate mounted on a plate cylinder. The inking device supplies ink to the plate mounted on the plate cylinder through an ink roller group. The fan roller is arranged in the vicinity of the ink roller group and driven to rotate. The fan roller includes a pair of opposing wheels, an air intake port, and a plurality of vane members. The air intake port is formed in at least one of the wheels. The first vane members each have two ends fixed to the pair of wheels, and discharge air, taken in through the air intake port, in a radial direction of the fan roller as the fan roller rotates.

### BACKGROUND OF THE INVENTION

The present invention relates to a printing press comprising a dampening device and inking device which respectively supply dampening water and ink to a plate mounted on a plate cylinder.

In a printing press of this type, roller stripping, i.e., a phenomenon in which dampening water supplied from a dampening device to a plate mounted on a plate cylinder attaches to the outer surface of an ink roller which forms an inking device, and so-called dampening (over-emulsification) occurs. As a countermeasure against these problems, air must be blown to the outer surface of the ink roller by a fan or air blowing means to vaporize moisture contained in the ink.

In a conventional printing press, a structure is proposed as shown in Japanese Patent Laid-Open No. 5-169633, in which an air supply pipe is provided to at least one ink roller of an ink roller group which forms an inking device, and air is supplied from the pipe to the outer surface of the ink roller. Another structure is also proposed as shown in Japanese Utility Model Laid-Open No. 6-032035, in which a fan is attached to a cover that covers the front surface of a printing unit, and air is blown from the fan to the surface of an ink oscillating roller.

In the former structure, as the air supply pipe and a fan are arranged outside the inking device, air does not reach some ink rollers of the ink group that are arranged on the inner side. In the latter structure, as the cover is located spaced apart from an inking device, it is difficult to blow air to the ink oscillating roller efficiently. Also, a common problem exists between the two structures. That is, pipes and valves are necessary to supply air to the air supply pipe and fan. This makes the structure complicated to increase the manufacturing cost.

### SUMMARY OF THE INVENTION

It is an object of the present invention to provide a printing press in which air can be efficiently blown to all ink rollers which constitute an inking device.

It is another object of the present invention to provide a printing press in which the structure is simplified and the manufacturing cost is decreased.

In order to achieve the above objects, according to the present invention, there is provided a printing press comprising a dampening device which efficiently supplies dampening water to a plate mounted on a plate cylinder, an inking device which supplies ink to the plate mounted on the plate cylinder through an ink roller group, and a fan roller which is arranged in the vicinity of the ink roller group and driven to rotate, the fan roller comprising a pair of opposing wheels, an air intake port formed in at least one of the wheels, and a plurality of first vane members, each having two ends fixed to the pair of wheels, to discharge air, taken in through the air intake port, in a radial direction of the fan roller as the fan roller rotates.

### BRIEF DESCRIPTION OF THE DRAWINGS

FIG. 1 is a view showing the schematic arrangement of a printing press according to the first embodiment of the present invention;

FIG. 2 is a perspective view showing the main part of the fan roller shown in FIG. 1;

FIG. 3 is a view for explaining drive coupling between the fan roller and ink rollers shown in FIG. 1;

FIG. 4A is a side view of a fan roller according to the second embodiment of the present invention;

FIG. 4B is a perspective sectional view taken along the line IVB of FIG. 4A;

FIG. 5 is a front view of a fan roller according to the third embodiment of the present invention;

FIG. 6 is a view showing the schematic arrangement of a printing press according to the fourth embodiment of the present invention;

FIG. 7 is a side view of the fan roller shown in FIG. 6; and

FIG. 8 is a view for explaining drive coupling between a fan roller and distribution roller according to the fifth embodiment of the present invention.

### DESCRIPTION OF THE PREFERRED EMBODIMENTS

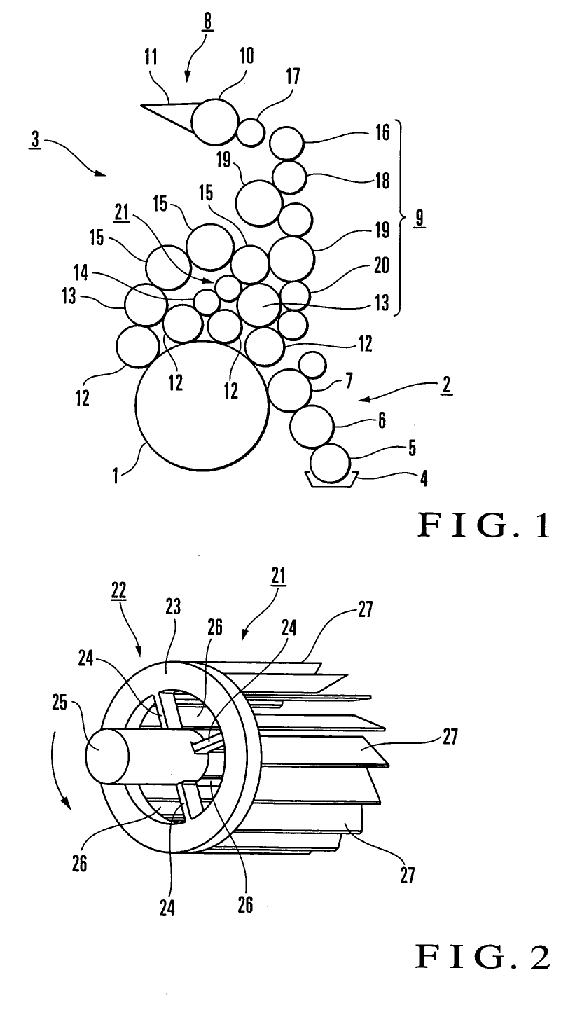

A printing press according to the first embodiment of the present invention will be described with reference to FIGS. 1 to 3.

As shown in FIG. 1, the printing press according to this embodiment comprises a plate cylinder 1 which opposes a blanket cylinder (not shown), a dampening device 2 which supplies dampening water to a plate mounted on the outer surface of the plate cylinder 1, and an inking device 3 which supplies ink to the plate mounted on the outer surface of the plate cylinder 1. The dampening device 2 comprises a dampening fountain roller 5 with a lower portion being dipped in dampening water in a fountain pan 4, a metering roller 6 in contact with the dampening fountain roller 5, and a dampening form roller 7 in contact with both the metering roller 6 and plate cylinder 1. The inking device 3 comprises an ink supply device 8 and ink roller group 9.

The ink supply device 8 comprises an ink fountain roller 10 and an ink fountain 11 which stores ink by the outer surface of the ink fountain roller 10 and a pair of dams. The ink roller group 9 includes four ink form rollers 12 in contact with the outer surface of the plate cylinder 1, a pair of oscillating rollers 13 in contact with the ink form rollers 12, a rider roller 14 in contact with the two inner ink form rollers 12, three distribution rollers 15 arranged above the rider roller 14, a distribution roller 16 to which the ink from the ink supply device 8 is to be supplied, a ductor roller 17 which comes into contact with the ink fountain roller 10 and distribution roller 16 alternately, a distribution roller 18 to which the ink from the distribution roller 16 is to be supplied, two oscillating rollers 19 to which the ink from the distribution roller 18 is to be supplied, and a rider roller 20 in contact with one of the oscillating rollers 13 (which is in contact with a fan roller 21 (to be described later)) and one of the oscillating rollers 19 (which is in contact with the corresponding distribution roller 15).

The fan roller 21 is arranged, in the space surrounded by the rollers of the ink roller group 9, to be adjacent to the ink form rollers 12, oscillating rollers 13, rider roller 14, and distribution rollers 15. As shown in FIG. 2, the fan roller 21 has a pair of wheels 22 (one wheel 22 is not shown) which oppose each other at a predetermined distance. Each wheel 22 has a ring-like rim 23, a shaft 25 supported at the central portion of the rim 23 by four spokes 24 and projecting in a direction perpendicular to the wheel 22, and four air intake ports 26 formed among the adjacent spokes 24. A plurality of vane members 27 horizontally extend between the wheels 22 equidistantly in the circumferential direction of the rim 23. The two ends of each of the plurality of vane members 27 are fixed to the peripheral portions of the wheels 22 such that the vane members 27 are inclined at the same angle with respect to the circumferential direction of the wheels 22.

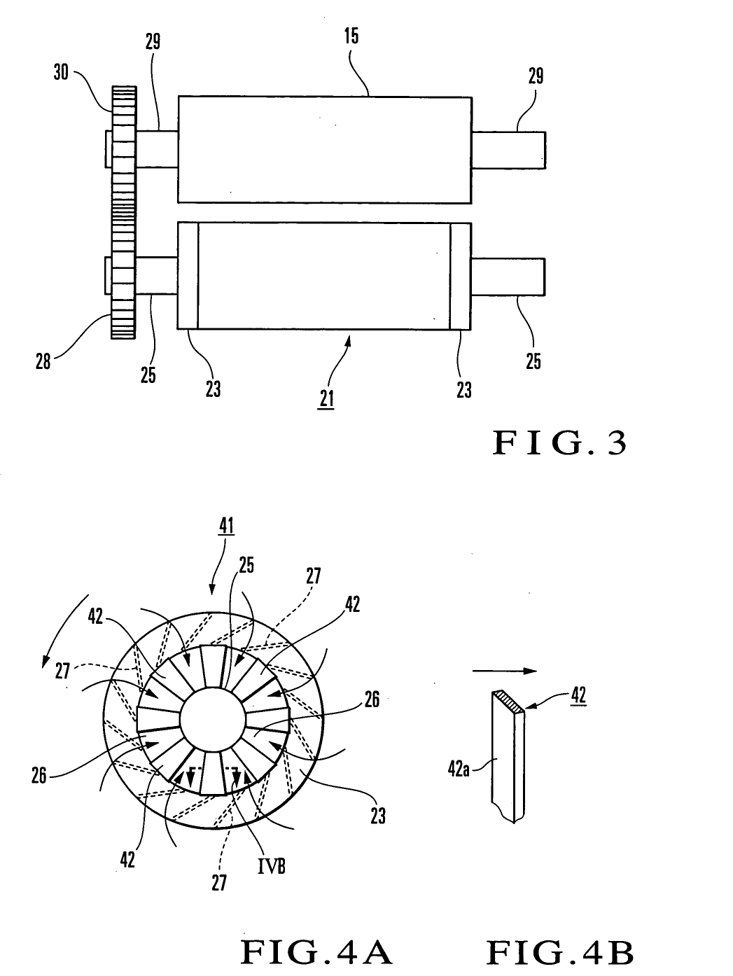

The surface (inclined surface) of each vane member 27 is inclined inwardly from outside the fan roller 21 at a predetermined angle with respect to the rotational direction of the fan roller 21. Thus, when the fan roller 21 rotates through the shaft 25, air in the fan roller 21 is discharged outside vane members 27 which rotate integrally with the fan roller 21, i.e., in the radial direction of the fan roller 21. When the air is discharged by the vane members 27, the interior of the fan roller 21 is set at a negative pressure, so that air near the fan roller 21 is taken into the interior of the fan roller 21 through the air intake ports 26. As shown in FIG. 3, a driven gear 28 is axially mounted on one end of the shaft 25 of the fan roller 21. The driven gear 28 meshes with a driving gear 30 axially mounted on a shaft 29 of the distribution roller 15 which opposes the fan roller 21.

In this arrangement, when the printing press drives to rotate the respective rollers of the ink roller group 9 and the distribution rollers 15 also rotate, the fan roller 21 rotates through the gears 30 and 28. When the fan roller 21 rotates, air taken in through the air intake ports 26 of the fan roller 21 is discharged by the vane members 27 in the radial direction of the fan roller 21 (radial direction of the fan roller 21). Thus, air is blown to the outer surfaces of the ink form rollers 12, oscillating rollers 13, rider roller 14, and distribution rollers 15 which are arranged in the vicinity of the fan roller 21. Consequently, the moisture attaching to the outer surfaces of the rollers 12, 13, 14, and 15 vaporizes to make the outer surfaces dry. Thus, roller stripping or dampening (over-emulsification) does not occur.

According to this embodiment, since the fan roller 21 is arranged at a position close to the ink roller group 9, air can be blown from the fan roller 21 to the ink roller group 9 efficiently. When the rollers of the ink roller group 9 rotate, the fan roller 21 also rotates automatically to discharge air. Thus, a controller which controls the fan and air blowing means becomes unnecessary. Also, as the pipes and valves become unnecessary, the structure can be simplified to decrease the manufacturing cost. Air can also be blown to the ink rollers located inside the ink roller group 9, so that roller stripping and dampening (over-emulsification) can be prevented more reliably.

The second embodiment will be described with reference to FIGS. 4A and 4B. A fan roller 41 according to this embodiment is different from the fan roller 21 of the first embodiment in that, in place of the spokes 24, a plurality of vane members 42 which constitute a propeller couple a shaft 25 to a rim 23. The second vane members 42 are provided to each of a pair of wheels 22, and the second vane members 42 of the two wheels 22 are arranged symmetrically. As shown in FIG. 4B, each second vane member 42 has an inclined surface 42a which is inclined inwardly from outside the fan roller 41 at a predetermined angle (corresponding to the slip angle of the propeller) with respect to the rotational direction of the fan roller 41. Hence, when the fan roller 41 rotates, air outside the fan roller 41 is forcedly taken into the fan roller 41 through air intake ports 26.

According to this embodiment, when the fan roller 41 rotates, air is forcedly taken into the fan roller 41 through the air intake ports 26 to increase the air pressure in the fan roller 41. Thus, the amount of air discharged by the second vane members 42 increases.

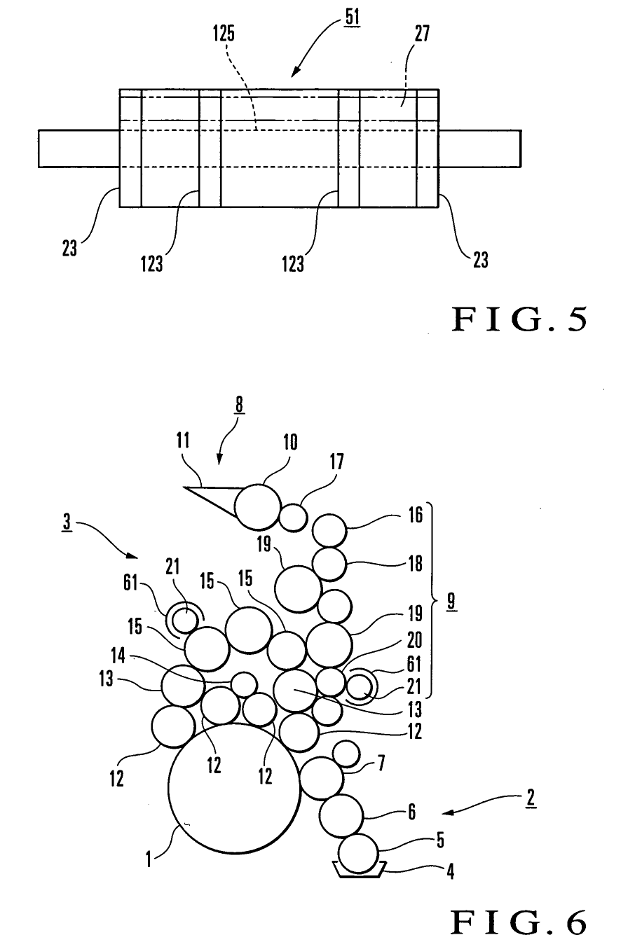

The third embodiment of the present invention will be descried with reference to FIG. 5. A fan roller 51 according to the third embodiment is different from the fan roller 21 of the first embodiment in that, between a pair of rims 23 arranged at the two ends of the fan roller 51, another pair of rims 123 are arranged, and vane members 27 are supported by the two sets of rims 23 and 123. In this case, the rims 123 comprise wheels 22, a shaft 125, and spokes 24, in the same manner as the rims 23. The shaft 125 extends through the fan roller 51 to support the rims 23 and 123. According to this embodiment, the vane members 27 are supported by a total of four rims, i.e., the rims 23 and 123, so that their strength increases.

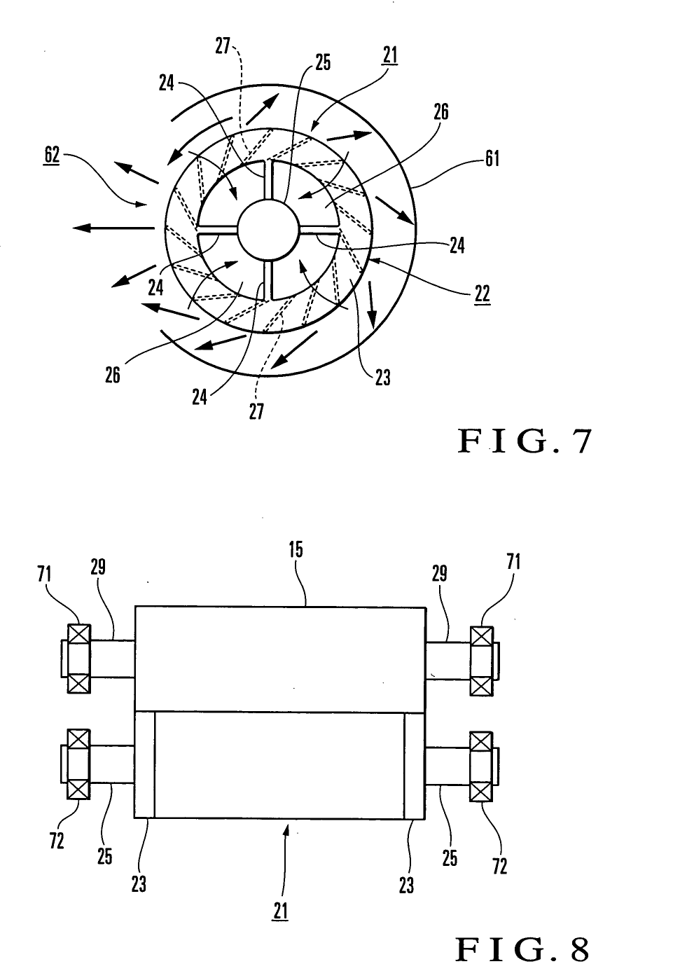

The fourth embodiment of the present invention will be described with reference to FIGS. 6 and 7. According to this embodiment, as shown in FIG. 6, two fan rollers 21 are arranged adjacent to distribution rollers 15 and a rider roller 20 which are located on the outer side of an ink roller group 9. Each fan roller 21 has a cylindrical (arcuate-section) casing 61 which covers the outer surface of the fan roller 21 and has a band-like opening 62. One casing 61 is arranged such that its opening 62 opposes the adjacent distribution roller 15, and the other casing 61 is arranged to oppose the rider roller 20. Air discharged from the peripheral portions of the fan rollers 21 abuts against the inner walls of the casings 61, as shown in FIG. 7, and is discharged through the openings 62 with an increased pressure. The pressure-increased air discharged through the openings 62 is blown toward the distribution rollers 15 and rider roller 20.

According to this embodiment, the air discharged from the fan rollers 21 is imparted with directivity by the casings 61. Thus, wasteful air blowing decreases to improve the air blowing efficiency.

The fifth embodiment of the present invention will be described with reference to FIG. 8. According to this embodiment, a fan roller 21 is arranged such that the outer surfaces of its rims 23 are in contact with the outer surface of a distribution roller 15. The two rollers 15 and 21 are rotatably supported by bearings 71 and 72. Thus, when the distribution roller 15 rotates, the friction between the outer surface of the distribution roller 15 and those of the rims 23 rotates the fan roller 21. The surfaces of the rims 23 which are in contact with the outer surface of the distribution roller 15 are coated with silicone or the like so the ink will not attach to them.

According to this embodiment, a driving mechanism such as a driving gear is not required, and the fan roller 21 can be rotatably driven by only the frictional force.

In the embodiments described above, the fan roller 21 or 41 is rotated interlocked with the ink roller group. Alternatively, only the fan roller 21 may be driven by an exclusive motor independently of the ink roller group. While the air intake ports 26 of the fan roller 21 or 41 are formed in both of the opposing wheels 22, they may be formed in only one wheel 22.

As has been described above, according to the present invention, air can be blown efficiently from a position close to the ink rollers. When the ink rollers rotate, air is automatically discharged from the fan roller. Thus, a controller which controls the driving operation of the fan or air blowing means becomes unnecessary. Pipes and valves also become unnecessary. This can simplify the structure to decrease the manufacturing cost.

Since air can be blown also to the ink roller on the inner side of the ink roller group, roller stripping or dampening (over-emulsification) can be prevented more reliably. As the air is taken into the fan roller forcedly, the amount of air to be discharged toward the ink rollers can be increased. Also, the air can be blown from the fan roller to a target ink roller efficiently.

What is claimed is:

1. A printing press comprising:
a dampening device which efficiently supplies dampening water to a plate mounted on a plate cylinder;
an inking device which supplies ink to the plate mounted on said plate cylinder through an ink roller group; and
a fan roller which is arranged in the vicinity of said ink roller group and driven to rotate,
said fan roller comprising
a pair of opposing wheels,
an air intake port formed in at least one of said wheels, and
a plurality of first vane members, each having two ends fixed to said pair of wheels, to discharge air, taken in through the air intake port, in a radial direction of said fan roller as said fan roller rotates.

2. A printing press according to claim 1, wherein said first vane members are equidistantly attached to said wheels to be inclined inwardly from outside said fan roller at a predetermined angle with respect to a rotational direction of said fan roller.

3. A printing press according to claim 1, wherein
said wheel comprises a ring-like rim, a shaft located at a center of said rim, and a plurality of spokes which couple said rim to said shaft, and
the air intake port is formed between adjacent ones of said spokes.

4. A printing press according to claim 1, wherein said fan roller is arranged in a space such that an outer surface of said fan roller is surrounded by said ink roller group.

5. A printing press according to claim 1, wherein said fan roller further comprises a plurality of second vane members which forcedly take air into said fan roller as said fan roller rotates.

6. A printing press according to claim 5, wherein each of said second vane members has an inclined surface which is inclined inwardly from outside said fan roller at a predetermined angle with respect to a rotational direction of the fan roller.

7. A printing press according to claim 1, wherein
said fan roller comprises at least one intermediate wheel between said pair of wheels, and
said first vane members are fixed to said pair of wheels and said intermediate wheel.

8. A printing press according to claim 1, further comprising a cylindrical casing which covers said fan roller,
wherein said casing has an opening to discharge air toward said ink roller group.

9. A printing press according to claim 1, wherein
said fan roller is arranged such that outer surfaces of said pair of wheels are in contact with an outer surface of one rotary roller which constitutes said ink roller group, and
when said rotary roller rotates, a frictional force between an outer surface of said roller and those of said wheels rotates said fan roller.

10. A printing press according to claim 1, further comprising:
a driven gear axially mounted on a shaft of said fan roller; and
a driving gear meshing with said driven gear and axially mounted on a shaft of one rotary roller which opposes said fan roller and constitutes said ink roller group.
